(19) United States
(12) Patent Application Publication
(10) Pub. No.: US 2003/0152660 A1
(43) Pub. Date: Aug. 14, 2003

(54) Process and device for reinforcing a convertible soft top

(75) Inventor: Thomas Schutt, Fuerstenfeldbruck (DE)

Correspondence Address: NIXON PEABODY, LLP, 8180 GREENSBORO DRIVE, SUITE 800, MCLEAN, VA, 22102, US

(73) Assignee: Webasto Vehicle Systems International GmbH, Stockdorf (DE)

(21) Appl. No.: 10/329,994

(22) Filed: Dec. 27, 2002

(30) Foreign Application Priority Data
Dec. 28, 2001 (DE) 101 64 500.7

(51) Int. Cl. B29C 43/00

(52) U.S. Cl. 425/406

(57) ABSTRACT

A process and a device for reinforcing a convertible soft top (34) or the like, especially for motor vehicle convertible tops, the convertible soft top (34) being entirely or partially underlain with reinforcing components (bow 32). At least one reinforcing component (bow 32) is molded directly onto the convertible soft top (34) in an injection mold (24). For the case in which the convertible soft top (34) is not to be joined over its entire surface to the reinforcing component (bow 32), the part of the convertible soft top (34) which is not to be connected to the reinforcing component is routed out of the casting mold (24) via a branch channel (36).

### BACKGROUND OF THE INVENTION

1. Field of the Invention

This invention relates to a process and a device for reinforcing a convertible soft top or the like, especially for motor vehicle convertible tops, the convertible soft top being entirely or partially underlain with reinforcing components.

2. Description of Related Art

Reinforcing components are used not only to support and shape convertible soft tops, but also for acoustic and thermal insulation of the convertible top. Examples of these reinforcing components are the bows of folding-and-sliding roofs guided in side guide rails or also large area, plate-like components in modern convertible tops (for example, RHT—retractable hard top).

In conventional convertible top systems, these reinforcing components are cemented under the convertible soft top or sealed to it. In doing so, generally aesthetically less attractive impressed areas or sunken spots in the region of these components are formed. Moreover, these adhesive or sealed connections have often proven less resistant so that the reinforcing components, after longer use, have detached in whole or in part from the convertible soft top. Another disadvantage of the known process is that the production of the reinforcing components and their joining to the convertible soft top are separate working steps so that the production process is relatively complex.

### SUMMARY OF THE INVENTION

A primary object of this invention is to devise a process and a device for reinforcing a convertible soft top or the like which enable good and permanent connection of the reinforcing components to the convertible soft top, which furthermore ensure a good support function and an aesthetically pleasing outer appearance of the convertible top without impressed areas and sunken spots, and which allow production which is more economical compared to the conventional process.

This object is achieved in accordance with the invention in that the reinforcing components are molded directly onto the convertible soft top in an injection mold. It has been found that, in this way, a good permanent connection between the convertible soft top and the reinforcing components is achieved, the transition from the reinforced areas to the unreinforced areas being configured such that impressed areas and sunken spots are avoided. In addition, the production process becomes more economical overall due to the formation of the reinforcing components and their joining to the convertible soft top taking place in a single working process.

In the process of the invention, it is provided that the convertible soft top which is to be reinforced is inserted into a plastic casting mold which corresponds essentially to the shape of the reinforcing component, so that it borders the mold cavity for forming the reinforcing component, and that the reinforcing component is injected then directly onto the convertible soft top in the casting mold by injection of a suitable plastic material. After setting of the plastic material, the finished convertible top can be removed from the casting mold.

In one preferred embodiment of the process, it is provided that the plastic material is a foam. These foam materials have relatively good strength properties, good stability of shape and outstanding acoustic and thermal insulation properties.

In many cases, the reinforcing component is connected only over one part of its surface facing the convertible soft top to the latter because, for example, the convertible soft top, when the convertible top is opening, will form a loop at this point. For such a case, it is provided, in accordance with the invention, that the part of the convertible soft top which is not to be connected to the reinforcing component is routed, for the molding-on process, via a branch channel away from the mold cavity, and for example, out of the casting mold.

For the case in which the convertible soft top, in the area of the reinforcing component, is intended to pass into a doubled convertible soft top, according to another embodiment of the invention, it is provided that the upper layer of the doubled convertible soft top is routed out of the casting mold via a branch channel.

A device for executing the process of the invention is characterized in that the casting mold is divided at least in the plane of the inserted convertible soft top into a top mold which supports the convertible soft top and a bottom mold which has the mold cavity for forming the reinforcing component. The plane of separation between the top mold and the bottom mold is essentially the plane which is defined by the convertible soft top.

The branch channels which are used for routing the convertible soft top out of the casting mold are made in the top mold according to another embodiment of the invention, i.e., the branch channels each continue from the mold cavity for forming the reinforcing component.

A further simplification of the casting mold arises when the top mold is divided once more in the area of the branch channel, the dividing joint being made as a branch channel.

Several embodiments of the invention are shown in the drawings and are explained in detail below.

### BRIEF DESCRIPTION OF THE DRAWINGS

FIG. 1 is a schematic perspective view a motor vehicle with a folding-and-sliding roof;

FIG. 2 is a partial section through the folding-and-sliding roof of FIG. 1 roughly corresponding to section line II-II;

FIG. 3 shows a casting mold for full-surface joining of a bow to the convertible soft top;

FIG. 4 shows a casting mold for partial-surface joining of a bow to the convertible soft top;

FIG. 5 shows a casting mold of a doubled convertible soft top with a bow.

### DETAILED DESCRIPTION OF THE INVENTION

FIG. 1 shows a motor vehicle 2 with a folding-and-sliding roof 4 for selectively opening and closing a roof cutout 6. The folding-and-sliding roof 4 comprises, essentially, a flexible convertible soft top 8 which is connected to several (in the example 4) bows 10 which are guided in lateral guide rails. To open the folding-and sliding roof 4, the bows 10 are pushed to the rear, the convertible soft top 8 forming loops which project upward, as is generally known.

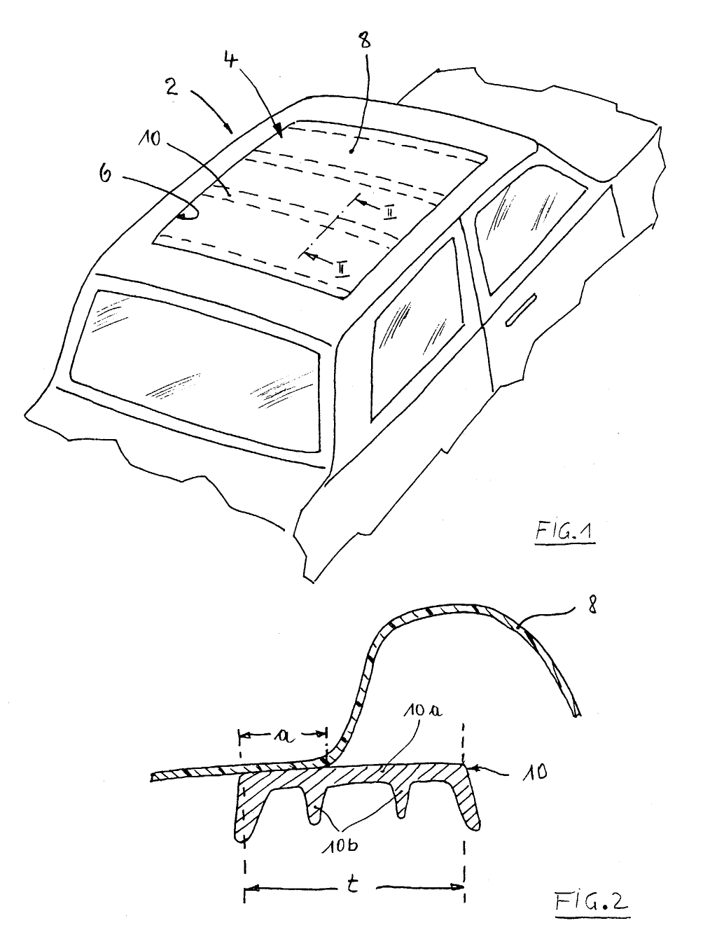

FIG. 2 shows a section roughly corresponding to the section line II in FIG. 1, however, the convertible soft top 8 not being stretched, as corresponds to the closed state of the folding-and sliding roof 4 shown in FIG. 1, but instead forms a loop which projects upward when the folding-and sliding roof 4 is opening, i.e., when adjacent bows 10 are pushed together. FIG. 2 further shows that the convertible soft top 8 is not connected over its entire surface, i.e., over the entire width t of the bow 10, but only over a range a; this enables larger, less sharply bent loops between the individual bows 10. The bow 10 is made as an essentially flat strip 10a with reinforced lengthwise ribs 10b on its bottom.

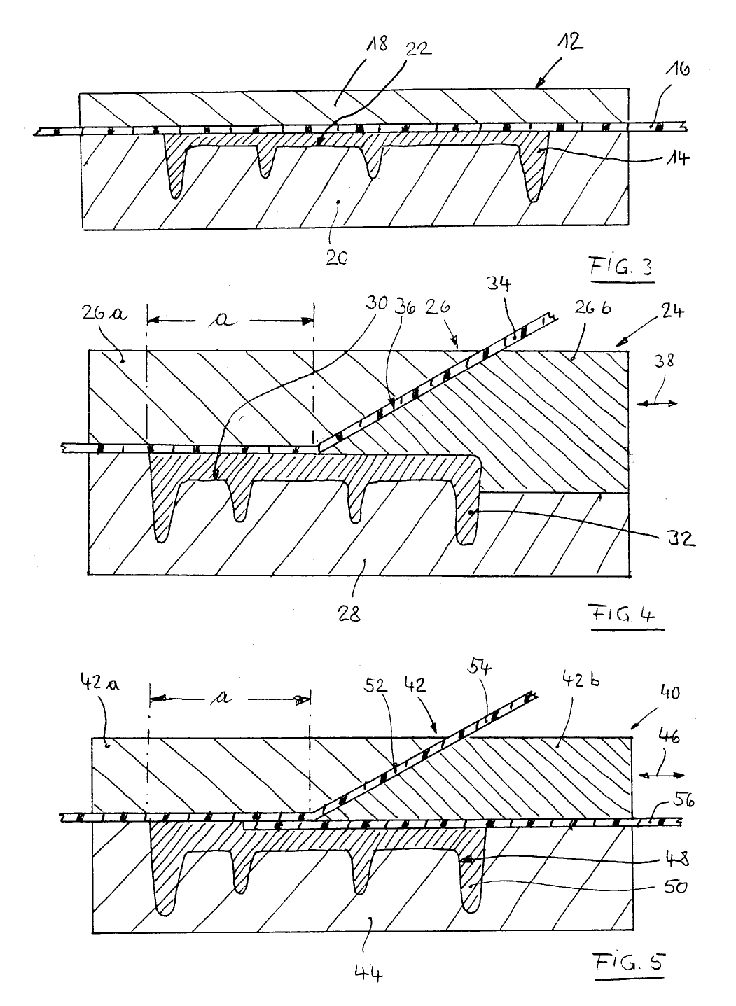

FIG. 3 schematically shows a casting mold 12 for molding the bow 14 to the convertible soft top 16. The bow 14 is shown in cross section, as in FIG. 2. The mold 12 encompasses a top mold part 18 and a bottom mold part 20. The bottom mold part 20 has a mold cavity 22 for forming the bow 14. The bow 14 in turn, as in the example from FIG. 2, has the shape of a flat strip with lengthwise reinforcing ribs formed on its bottom. The bottom mold part 20 is, moreover, provided with injection channels for injecting the plastic material which forms the bow 14 in the conventional manner which is therefore not detailed.

In order to join the convertible soft top 16 to the bow 14, the convertible soft top is inserted into the casting mold 12, the mold is closed, and then the plastic material which forms the bow 14 is injected, its being intimately joined to the convertible soft top 16. In doing so, the transitions from the reinforced areas to the nonreinforced areas of the convertible soft top can be made such that impressed areas and sunken spots do not occur. As was already stated above, the plastic material is preferably a foam material so that the injection process can also be called a foaming-on process.

FIG. 4 shows a casting mold 24 which has a top mold part 26 and a bottom mold part 28. The bottom mold part 28 has a mold cavity 30 for forming a bow 32. The bow 32, in turn, has the shape of a flat strip with lengthwise ribs formed on its bottom. The convertible soft top 34 is to be joined to the bow 32 as in the example of FIG. 2, however, only over the width range a. For this purpose, part of the convertible soft top 34, i.e., the part which is not to be connected to the bow 32, is routed out of the casting mold 24 via a branch channel 36 which is made in the top mold 26. As indicated in FIG. 4, the top mold part 26, in the area of the branch channel 36 is divided into a fixed mold part 26a and a slide-like mold part 26b which can be moved in the directions of the double-arrow 38, the dividing joint between the mold part 26a and the mold part 26b forming the branch channel 36.

In order join the convertible soft top 34 to the bow 32 in the manner shown in FIG. 4, for example, the convertible soft top 34 is placed on the bottom mold part 28. Then, the mold part 26a is placed on the bottom mold part 28 and the convertible soft top is guided upward along the lower edge of the mold part 26a to the outside. Then, the mold part 26b is inserted, the joint of separation between the mold part 26a and the mold part 26b forming the branch channel 36. Then, the plastic material is injected for forming the bow 32. After curing of the bow 32, the mold part 26b is slid into the open position and the mold part 26a is lifted off the bottom mold 28 so that the component comprising the convertible soft top 34 and the bow 32 can be removed.

FIG. 5 shows a casting mold 40 which comprises a top mold part 42 and a bottom mold part 44. The top mold part 42, as in the example in FIG. 4, is divided into a fixed mold part 42a and a movable, slide-like mold part 42b which can be pushed in the direction of the double-arrow 46. In the bottom mold part 44, a mold cavity 48 is made for forming a bow 50. Between the fixed mold part 42a and the movable mold part 42b, a branch channel 52 is formed via which the part of the first convertible soft top 34 which is not to be connected to the bow 50 can be routed out of the casting mold 40, as was explained relative to the example of FIG. 3. As FIG. 5 indicates, the bottom mold 44, on the one hand, and the mold part 42b of the top mold 42, on the other hand, are made such that a space remains between them for inserting a second convertible soft top 56 which is cemented to the first convertible soft top 54 in the area of the middle of the bow. In the part which is on the right in FIG. 5, accordingly, the convertible soft top is made doubled in the manner necessary for certain applications (first convertible soft top 54, second convertible soft top 56).

It should be pointed out here that FIGS. 3 to 5 show certain embodiments to which the invention is however not limited. Thus, for example, a casting mold can have several mold cavities for forming several or all bows of a folding-and-sliding roof, the areas of the convertible soft top which lie between the bows being guided out of the casting mold via suitable branch channels. Moreover other reinforcing components can be molded to the convertible soft top, can support large surface areas of the convertible soft top and leave exposed only small areas which are necessary for bending or folding the convertible top, as need not be explained in detail here.

What is claimed is:

1. Process for producing a reinforced convertible soft top for convertible motor vehicle in which the convertible soft top is at least partially underlain with at least one reinforcing component, comprising the steps of placing at least one portion of the convertible soft top in a casting mold, and molding the at least one reinforcing component directly onto the convertible soft top in the casting mold.

2. Process as claimed in claim 1, wherein the placing step comprising disposing the convertible soft top which is to be reinforced so that it borders a mold cavity of the mold in which the at least one reinforcing component is formed, and wherein said molding step comprises injecting of a plastic material into the mold cavity.

3. Process as claimed in claim 2, wherein the plastic material is a foam material.

4. Process as claimed in claim 1, wherein part of the convertible soft top is routed away from the mold cavity via a branch channel of the mold so that the at least one reinforcing component is connected to the convertible soft top only over a portion of a surface of the at least one reinforcing component that faces the convertible soft top.

5. Process as claimed in claim 1, wherein said surface of the at least one the reinforcing component is flat, and wherein ribs are formed on a side of the reinforcing component that is opposite said surface.

6. Process as claimed in claim 1, wherein the convertible soft top is joined to a second convertible soft top in an area of the at least one reinforcing component for creating a doubled convertible soft top, wherein part of a one of the convertible soft tops which constitutes an upper layer of the doubled convertible soft top is routed out of the casting mold via a branch channel.

7. Process as claimed in claim 1, wherein at least one the reinforcing component is a roof bow having a flat upper surface and ribs formed on a lower side of the reinforcing component.

8. Device for producing a reinforced convertible soft top for convertible motor vehicle in which the convertible soft top is at least partially underlain with at least one reinforcing component comprising a casting mold which is divided at least into a top mold part which is configured to receive and support the convertible soft top and a bottom mold part which has at least one mold cavity for forming the at least one reinforcing component directly against at least a portion of the convertible soft top received and supported by the upper mold part.

9. Device as claimed in claim 8, wherein the top mold part has a branch channel by which part of the convertible soft top is routed away from the at least one mold cavity so as not to be joined to the at least one reinforcing component formed in the mold cavity.

10. Device as claimed in claim 9, wherein the top mold part is divided into parts which form a joint between them which defines the branch channel.

11. Device as claimed in claim 7, wherein said parts into which the top mold is divided comprise a fixed mold part and a movable, slide mold part.
